(19) United States
(12) Patent Application Publication
(10) Pub. No.: US 2007/0250772 A1
(43) Pub. Date: Oct. 25, 2007

(54) Clock-Based User Interface for Hdd Time-Shift Buffer Navigation

(75) Inventor: Vlatko Milosevski, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,785

(22) PCT Filed: May 31, 2005
(86) PCT No.: PCT/IB05/51769

§ 371 Date: Nov. 29, 2006

Related U.S. Application Data
(60) Provisional application No. 60/576,227, filed on Jun. 2, 2004.

(51) Int. Cl. G06F 3/048

(52) U.S. Cl. 715/716

(57) ABSTRACT

A time-shift buffer of recorded programming whose time of recording extends between a predetermined lower limit up to the present time is navigated by the user by means of a displayed clock face in selecting a desired program for immediate or deferred playback. Rewinding of hands on the clock face, under user control, causes the minute hand to enter a sector of the clock face representative of a time interval during which incoming programming was recorded. An identifier of the program is displayed in concert with the clock hand positioning, so that the user may at any point in the navigation select the currently-identified program for playback.

The present invention relates to a clock-face-based indicator on a display, and more particularly to clock-face-based indicator operable by rewinding clock hands.

At present, Hard Disc Drive (HDD) video recorders are rapidly gaining in popularity. It is a common belief that the HDD-based Personal Video Recorder (PVR), also called a Digital Video Recorder (DVR) based on the HDD, will dominate the consumer electronics market. One major benefit of the HDD recorder is the feature of concurrent audiovisual (A/V) playback and recording, also known as time shifting, which allows previously recorded or currently recording programs to be selected for immediate playback by the same device that is doing the recording. Another major benefit of the HDD recorder is large storage capacity. A challenge of great concern is to provide a simple, intuitive and user-friendly interface through which the ordinary user can immediately understand, and be comfortable with, the HDD concept.

Navigation through the recorded programming is typically implemented by displaying a time shift bar whose sectioning corresponds to the order of recorded programs stored in a time shift buffer. One end of the bar represents the present time, and the other end represents the lower temporal limit of the buffer.

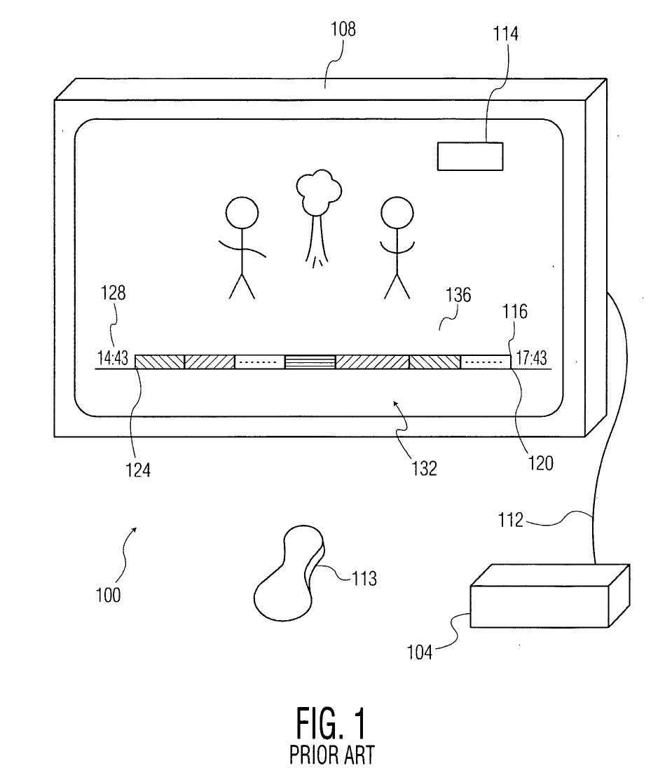

A known user interface for an HDD PVR is shown in FIG. 1. The time shifting system 100 of the prior art includes a PVR 104, a display 108, a cable 112, and a remote control 113. The connection of the PVR 104 to the cable provider by means of a set-top box and the provider's distribution network is not shown. The display 108 is presently showing a scene of an incoming broadcast that the PVR 104 is simultaneously recording on its internal HDD (not shown), as evidenced by the record button 114 displayed on-screen. The recordings of the last three hours are symbolically represented on the display 108 by a time shift bar 116, whose right end 120 shows the present time, 17:43 (or 5:43 P.M.), and whose other end 124 shows the lower temporal limit 128, 14:43 (or 2:43 P.M.), of the time shift buffer containing the recorded programming. A screen message 132 indicates that the time shift buffer is full, which means that the buffer length is 3 hours. The various rectangular sections of the time shift bar 116, distinguishable from each other by their differing hatchings and other markings, represent respective time intervals, and recordings made in those intervals, during the past 3 hours. Each of the program titles 136 is displayed above its respective section representative of that program and its time interval. The time shift bar 116 continuously shifts to the left as the incoming broadcast is stored, and recording older than 3 hours is shifted out of the buffer. Alternatively and conversely, shifting may occur to the right, with incoming programming first appearing at the left end of the bar 116.

A user may operate the remote control 113, or possibly the PVR 104, to move a screen cursor (not shown) within a desired time interval in the time shift bar 116 to select the respective recorded program for immediate or deferred playback. Although hatching is shown in FIG. 1 to distinguish adjacent sections of the time shift bar 116, adjacent sections are usually differently-colored. Red is often used to mark a program for permanent storage, so that when the program falls off the time shift bar 116 it will be transformed into a permanent title available on the PVR 104. Additional coloring of the sections is also possible, e.g., by channel or genre.

Many users, however, are not familiar with this concept and find it too confusing and difficult to understand. In addition, although in the above example the time shift buffer is 3 hours long, with a typical length of between 1 to 8 hours, it is expected that this length will increase to 16, 32 or even more hours with subsequent growth in the capacity of HDD's. As the time shift buffer size increases, granularity worsens—there is a decrease in the size of on-screen sectioning and program titles, making the user interface less readable and understandable. The granularity problem is, moreover, exacerbated if the recorder is connected to device with a small display such as a small television.

The present invention has been made to address the above-noted shortcomings in the prior art. It is an object of the invention to provide a device, a method operable on the device, and a computer program for performing the method, wherein the device includes a display, and a processor configured to show a clock face on the display. The processor is further configured to show hands that rewind so that, for a predetermined time span into the past that is allocated among predetermined time intervals, the processor causes, while a time that the hands currently represent falls within any of the intervals, at least one of: display, on the display, of an item corresponding to the interval containing the time currently represented by the hands; and enablement for the selection of playback of a recording, if any, associated with the interval.

Details of the invention disclosed herein shall be described with the aid of the figures listed below, wherein:

FIG. 1 is a depiction of a known HDD PVR system, and it s time-shift-bar-based user interface for navigating the time shift buffer;

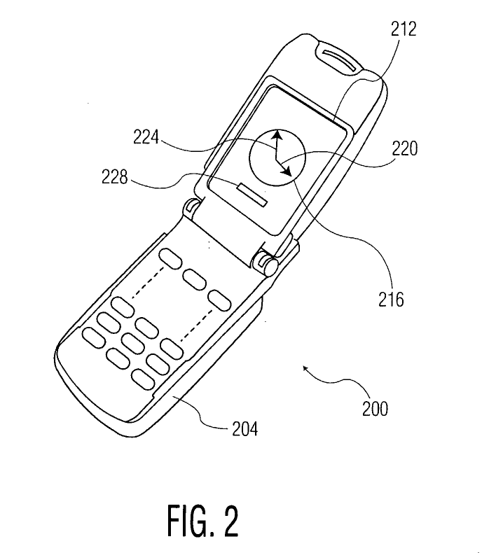

FIG. 2 is a perspective diagram of a personal digital assistant (PDA) equipped for clock-based time-shift-buffer navigation in accordance with the present invention;

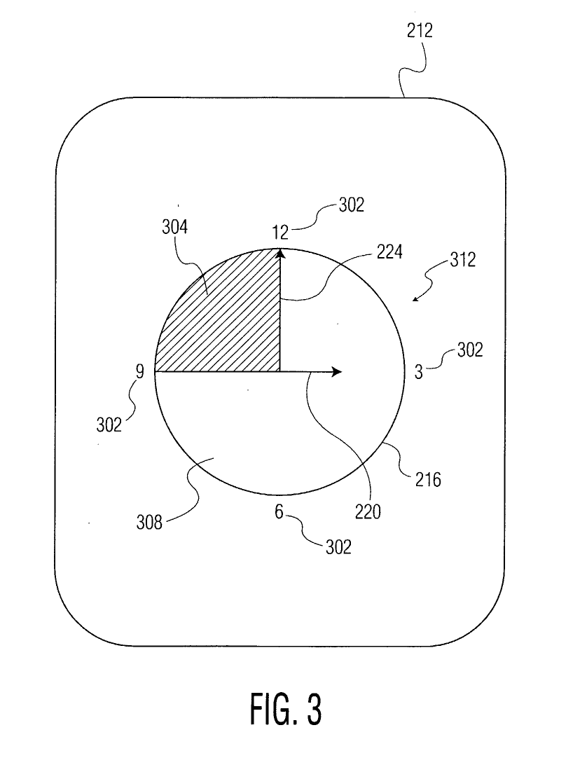

FIG. 3 is a more detailed view of the display shown in FIG. 2 with respect to particular time shift buffer contents;

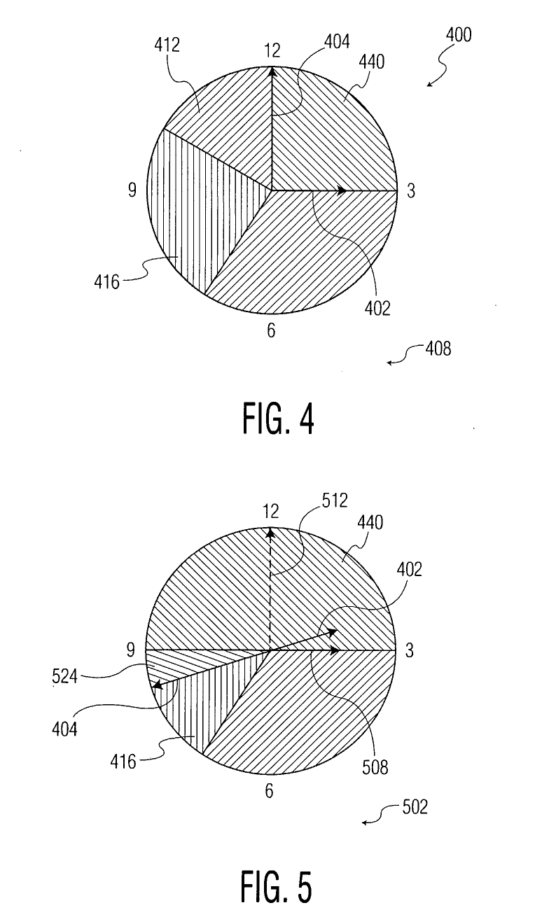

FIG. 4 is a view of a clock face similar to that in FIG. 3, but with different buffer contents;

FIG. 5 is a view of the clock face of FIG. 4 after the time is rewound by 20 minutes;

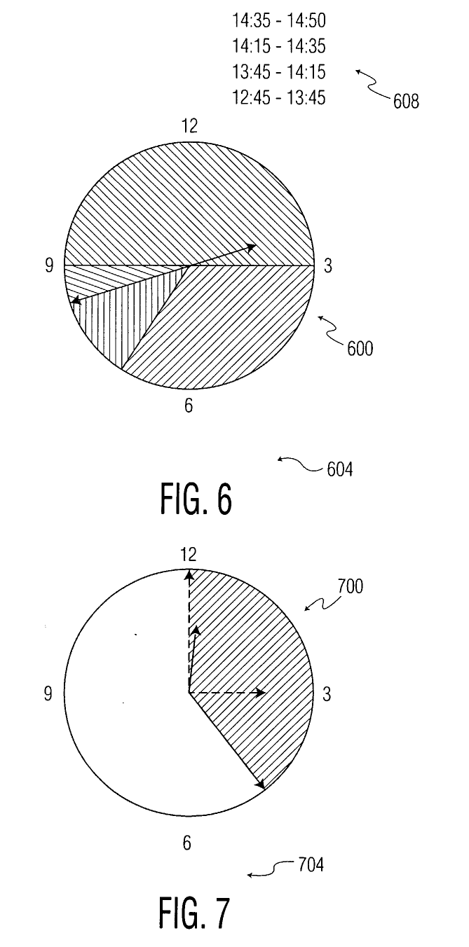

FIG. 6 is a view of the clock face of FIG. 5 configured with an alternative present time display scheme and with a table corresponding to the clock face; and

FIG. 7 is a view of the clock face of FIG. 3 with different buffer contents and with the time being rewound to near the end of the buffer.

The user interface for an HDD PVR in accordance with the present invention enjoys a reduced screen-area footprint, giving rise to potential applications in portable HDD recorders equipped with a small display and mini HDD-based devices such as personal digital assistants (PDAs), video MPEG players, etc.

FIG. 2 shows, by means of illustrative and non-limitative example, a PDA 200 equipped for clock-based time-shift-buffer navigation according to the present invention. The PDA 200 has a base 204, and a flip-top 208 housing a display 212. The display 212 shows a clock face 216, an hour hand 220 and a minute hand 224. The display 212 further includes a selectable-program title field 228.

The base 204 incorporates a processor (not shown), and a mini-HDD having a time shift buffer (not shown) although, alternatively, a remotely-located HDD may be employed in communication with the processor. The processor, implemented in any suitable combination of hardware, firmware and/or software, wirelessly receives programming, displays the programming on the display 212 or transmits the programming for remote display on another device, records the programming in a resident or remote time-shift buffer, and operates according to an input unit, such as a keyboard 232, under user control. The user interface of the present invention is, however, not limited to realization in a PDA or any other particular device. Thus, for instance, a remote control may serve as an input unit, and an external processor and/or display may be utilized. Likewise, it is within the intended scope of the invention that the display may be embodied in any type of screen or otherwise, a holographic image for example.

FIG. 3 is a more detailed view of the display 212 of FIG. 2 with respect to particular time shift buffer contents. The clock hands 220, 224 can be rewound or wound forward under operator control via the input unit 232 to navigate the time-shift buffer of recorded programming. In the current embodiment shown, the displayed “navigation” clock hands 220, 224 at this moment “overlay” so as to exclude from view another pair of “present time” clock hands that keep time in the conventional manner by means of steady clockwise rotation on the clock face. The present time is accordingly 15:00 (or 3 P.M.). Time indicia 302 may be arranged around the clock face to enhance instantaneous recognition that a clock face is being displayed.

The hatched area 304 of the upper left quadrant of the clock face 216, which more likely would actually be implemented with coloring rather than hatching, indicates that programming has been recorded continuously for the past quarter hour. This user interface is intuitive, since rewinding the hands 220, 224 so that the minute hand 224 sweeps across the hatched area 304 would position the hands to read 14:45, i.e., a quarter hour prior to the present time. According to the clock face 216 shown in FIG. 3, further rewinding of the hands 220, 224 would sweep the minute hand 224 into a “transparent region” 308 of the clock face, a region colored in the background color of the display, i.e., the color of the display region 312 surrounding the clock face 216. The transparency indicates that no programming in the time-shift buffer precedes the aforementioned recording made between 14:45 and 15:00 and, consequently, that program recording was initiated by the PDA 200 merely fifteen minutes ago. The selectable-program title field displays the title of the program currently indicated by the navigation clock hands 220, 224. Provided that this program is at least 20 minutes long and that the user does not navigate the clock hands 220, 224 by means of the keyboard 232, the selectable-program title field will retain display of the same title 5 minutes from now, at 15:05, when the now-hidden, present-time clock hands will have swept out from under the navigation clock hands 220, 224 to indicate the time to be 15:05.

FIG. 4 is a view of an exemplary clock face 400 similar to that in FIG. 3, but with different buffer contents. Although multiple colors of a palette are preferable for distinguishing adjacent regions of the clock face 400, black and white coloring will suffice as long as the displayed texture or other characteristic distinguishes immediately adjacent regions of the display from each other. In the former multi-color displays, red may be used to mark programs that are to be retained for selection and playback even after they shift out of the time-shift buffer.

As in FIG. 3, the navigation hands 402, 404 indicate the present time; however, unlike the time-shift buffer navigable by means of the clock face 216 of FIG. 3, which contains merely a quarter hour of recorded programming, the time-shift buffer navigable by means of the clock face 400 contains at least an hour of recorded programming. The selectable-program title field 408 displays the title of the program currently being. recorded, and being represented on-screen by the hatched region or sector 412. The border between the current region 412 and the previous region 416 indicates that recording of “Dances with Wolves” began at 14:50. Recording of the program corresponding with region 416 began at 14:35 and ended at 14:50, and so on around the clock face 400. The start of recording time for the program corresponding to region 440 is no later than 14:00, but may, and generally would be, earlier. Navigating backward in time, starting at 15:00 and past the region 440 causes the display 212 to overwrite the currently displayed region 412, since the temporal length of navigation has exceeded an hour. In this sense, the clock face of the present invention temporally layers a representation of the time-shift buffer, and efficiently confines display at any given moment merely to a currently top layer that extends back in time no more than an hour.

Time-shift-buffer navigation is demonstrated in FIG. 5 which is a view of the clock face of FIG. 4 after the time is rewound by 20 minutes. The rewinding/forwarding by means of the input device 232 can be continuous, as through the pressing of a “fast forward/backward” button, or can jump from region to adjacent region in a “skip forward/backward” manner. In the former case, the selectable-program title field 502 preferably displays the same title continuously as the minute hand 404 traverses the corresponding region, switching immediately to the appropriate title as an adjacent region is entered and retaining display of that title until a subsequent region is entered. Here, in FIG. 5, the twenty-minute rewinding of the navigation hands 402, 404 is assumed to be nearly instantaneous, and the present time is shown by present-time clock hands 508, 512 which are now displayable as a result of the rewinding. The present-time clock hands 508, 512 must be made distinguishable from the navigation clock hands 402, 404 and are shown here, for example, as comprised of dotted lines. The title of the program “Meet the Press” is the item or tag currently displayed in the selectable-program title field 502. Accordingly, a comparison of FIGS. 4 and 5 shows that the region 416, not identified in FIG. 4, is now identified in FIG. 5 as corresponding to the program entitled “Meet the Press.” FIG. 5 also expands on FIG. 4 by showing the starting time for recording the program corresponding to region 440, namely 13:45. It is further seen that the time-shift buffer contains a previously-recorded program, corresponding to region 524, whose recording time ended at 13:45.

Once the user has moved the navigation clock hands 402, 404 to the desired program to enable its selection, the appropriate button on the keyboard 232 is actuatable to select the program for immediate or deferred playback. It is also possible to configure the PDA 200 so that the navigated-to program is automatically selected, without further actuation, after a pre-set amount of time. Preferably, in either case, the selected program is played back starting at the beginning of the program, although the navigated-to time may be used to mark the starting point of playback within the program.

Although the selectable-program title field 502 is utilized as the user's navigation tracker for purposes of making a program selection, the invention is not limit ed to such implementation. The PDA 200 may, for instance, additionally or alternatively include a speech synthesizer that announces program titles during navigation. As another alternative embodiment of the present invention, navigation may function merely to identify the current time interval to the user, thereby serving, for example, as a compact user interface that allows the user to scan a memory device.

FIG. 6 is a diagram of a clock face 600 similar to the clock face of FIG. 5, but incorporating optional labeling features. The present-time clock hands are replaced with a digital representation 604, whose display is withheld while the navigation and present-time hands coincide. In addition, a table 608 optionally may be displayed near the clock face 600. The table entries include the title, starting time and ending time for any program currently displayed. Although the ending and starting times of the most current and the least current of the displayed programs, respectively, are not given on-screen merely by virtue of the clock face 600, these may conveniently be provided in the table, optionally along with additional entries that extend further into the past or future.

FIG. 7 is a view featuring an exemplary special case of what a clock face 700 according to the present invention looks like as a result of navigation toward the temporal lower limit of the time-shift buffer. Since the entry end of the time-shift buffer corresponds to the present time, which is shown in FIG. 7 to be 15:00, and no recording exists prior to 12:00, it can be inferred from FIG. 7 that the time-shift buffer is 3 hours long, extending from 12:00 to 15:00. The transparent or unfilled part of the clock face is, as mentioned above, preferably in the background color of the display. Navigation to the transparent part would remove the selectable-program title field 704, by, for example, causing a blank item to be displayed.

As has been demonstrated above, clock-based time-shift-buffer navigation by means of the user interface of the present invention reduces the screen footprint in conformance with the small form factor of modem, mobile, and particularly hand-held devices. This is accomplished by spiraling the conventional time-shift bar into a layered, symmetrical configuration affording display of merely an hour's worth of programming at a time. Moreover, the intuitive notion of rewinding a clock is leveraged to provide an easily-understandable user navigation tool.

While there have been shown and described what are considered to be preferred embodiments of the invention, it will, of course, be understood that various modifications and changes in form or detail could readily be made without departing from the spirit of the invention. For example, although round, and particularly circular, clock faces have been disclosed herein, the clock face may be of any shape as long as concentric hands sweep out time interval regions on the clock face. It is therefore intended that the invention be not limited to the exact forms described and illustrated, but should be constructed to cover all modifications that may fall within the scope of the appended claims.

What is claimed is:

1. A device comprising:
a display (212); and
a processor (204) configured to display on the display (212) a clock face (216), and hands (220, 224) that rewind so that, for a predetermined time span into the past (120, 124), said time span being allocated among plural predetermined time intervals (412, 416, 440, 524), the processor causes, while a time that the hands currently represent falls within any of the plural intervals, at least one of:
display, on the display, of an item corresponding to the interval containing said time that the hands currently represent (408); and
enablement for the selection (232) of playback of a recording associated with said interval if said interval has an associated recording (524, 608).

2. The device of claim 1, wherein said predetermined time span extends to a lower temporal limit (124, 700), regions of the clock face correspond to said time intervals (412, 416, 440, 524), and rewinding of said hands, over a clock face time span that exceeds an hour and does not exceed said lower temporal limit, overwrites, for purposes of current display, at least one of the regions (416) with another of the regions (524).

3. The device of claim 1, wherein regions of the clock face correspond to said time intervals (412, 416, 440, 524), and wherein, at any given time, each of the time intervals corresponding to said regions displayed intersects a time span of one hour back from the time represented by said hands (412, 416, 440, 524).

4. The device of claim 1, further including an input unit operable by a user to control the rewinding of the hands (232).

5. The device of claim 1, wherein the processor causes said enablement, said device further including an input unit operable by a user to perform the selecting for playback (232).

6. The device of claim 1, wherein said at least one comprises said display, on the display (212), of an item.

7. The device of claim 6, wherein said at least one further comprises said enablement (232).

8. The device of claim 1, wherein said processor is further configured to display on the clock face, concurrently with said hands that rewind, hands that show the present time (508, 512) and that are displayed in a manner distinguishable from that of said hands that rewind (402, 404).

9. The device of claim 1, said processor is further configured to display digits representative of the present time (604), the display of said digits being withheld while said hands show the present time.

10. The device of claim 1, wherein said predetermined time span extends to a lower temporal limit (124, 700), and wherein time prior to said lower temporal limit is represented in a background color of the display (308).

11. The device of claim 1, wherein regions of the clock face correspond to said time intervals (412, 416, 440), said device being further configured to display on the display (212) an automatically and continuously updated table (608) showing starting times, ending times and titles of recorded programs at least one of which programs corresponds to the region or regions (412, 416, 440, 524) currently displayed on the clock face, an earliest and a latest of the starting times being, respectively, a starting time of the earliest program, and an ending time of the latest program, to correspond to a respective currently displayed region.

12. The device of claim 1, wherein regions (412, 416, 440, 524) of the clock face correspond to said time intervals, and wherein, for a given one of said hands (404), the causing by the processor is operative for a time interval corresponding to a currently displayed region (524) of said regions while said given one of said hands is within said currently displayed region.

13. The device of claim 1, wherein regions (412, 416, 440, 524) of the clock face correspond to said time intervals and respectively represent recordings of different program content (608), any two immediately-adjacent, currently-displayed ones of said regions being differently colored (416, 524).

14. The device of claim 1, wherein regions (412, 416, 440, 524) of the clock face correspond to said time intervals and recordings associated with time intervals and are differently colored (416, 524), one of the colors being reserved to mark a region for permanent storage.

15. A computer-readable medium containing instructions for a processor connected to a display, execution of the instructions by the processor causing:
display of a clock face (216) on the display (212); and
display, on the clock face, of hands (220, 224) that rewind so that, for a predetermined time span in the past (120, 124), said time span being allocated among plural predetermined time intervals (412, 416, 440, 524), the processor causes, while a time that the hands currently represent falls within any of the plural intervals, at least one of:
display, on the display, of an item corresponding to the interval containing said time that the hands currently represent (408); and
enablement for the selection (232) of playback of a recording associated with said interval if said interval has an associated recording (524, 608).

16. A method comprising the steps of:
displaying a clock face (216) on a display (212); and
displaying, on the clock face, hands (220, 224) that rewind so that, for a predetermined time span in the past (120, 124), said time span being allocated among plural predetermined time intervals (412, 416, 440, 524), the processor causes, while a time that the hands currently represent falls within any of the plural intervals, at least one of:
display, on the display, of an item corresponding to the interval containing said time that the hands currently represent (408); and
enablement for the selection (232) of playback of a recording associated with said interval if said interval has an associated recording (524, 608).

17. The method of claim 16, wherein said predetermined time span extends to a lower temporal limit (124, 700), regions of the clock face correspond to said time intervals (412, 416, 440, 524), and rewinding of said hands, over a clock face time span that exceeds an hour and does not exceed said lower temporal limit, overwrites, for purposes of current display, at least one of the regions (416) with another of the regions (524).

18. The method of claim 16, wherein regions of the clock face correspond to said time intervals (412, 416, 440, 524), and wherein, at any given time, each oft he time intervals corresponding to said regions displayed intersects a time span of one hour back from the time represented by said hands (412, 416, 440, 524).

19. The method of claim 16, further comprising the step of controlling, by a user in operating an input unit (232), the rewinding of the hands.

20. The method of claim 19, wherein the rewinding of the hands causes said enablement, said method further comprising the step of operating, by a user, an input unit (232) to perform the selecting for playback.

21. The method of claim 16, wherein the processor causes said display of an item (408), said item comprising, if a recording has been made during said time interval (412), a tag that identifies said recording.

22. The method of claim 16, further including the step of displaying on the clock face, concurrently with said hands that rewind, hands that show the present time (508, 512) and that are displayed in a manner distinguishable from that of said hands that rewind.
